(19) United States
(12) Patent Application Publication
(10) Pub. No.: US 2012/0034839 A1
(43) Pub. Date: Feb. 9, 2012

(54) CONSTRUCTION TOY SYSTEM WITH UNIVERSAL HUB

(76) Inventor: Richard Michael Murphy, Windsor, CA (US)

(21) Appl. No.: 12/849,643

(22) Filed: Aug. 3, 2010

(51) Int. Cl. A63H 33/08; F16B 7/00

(52) U.S. Cl. 446/124; 403/361

(57) ABSTRACT

A connector element for a space structure of a type utilizing a plurality of struts. The connector element includes first and second subparts, at least one strut receiving element having a strut receiving socket emanating from each of the subparts, the subparts being rotatable with respect to one another along a common axis.

### TECHNICAL FIELD

The present invention is directed toward providing improved structural elements useful in construction of space structures such as toy systems of the type that employs struts and connector hubs. The present invention proposes the use of hubs having subparts which are capable of being articulated with respect to one another allowing rods emanating therefrom to do so with enhanced degrees of freedom allowing the construction of multiple and new spatial constructs heretofore unavailable.

### BACKGROUND OF THE INVENTION

There are a wide variety of kits for rod and hub construction toy sets, the majority of which are designed such that receptor slots on the hubs are fixed allowing only discreet angular placement of the various struts emanating therefrom.

The present invention is ideally suited to enhance the construction toy made the subject of U.S. Pat. Nos. 5,061,219, 5,137,486, 5,199,919, 5,238,438 and others commonly owned, the disclosures of which are incorporated by reference herein. A construction toy system as disclosed in the above-referenced patents is marketed under the trademark K'NEX®. In this regard, reference is made to FIGS. 1 and 2 of the '219 patent illustrating the hub-like connector element of the K'NEX® system as well as an enlarged fragmentary perspective view of a portion of the element shown in FIG. 1. The hub-like connector element 10 includes a central hub cylinder 11 and radiating spokes 12. As shown in the '219 patent, there are eight sockets 14 supported by radial spokes 12 each comprising an endwall 15 and spaced-apart, opposed gripping elements 16. Sockets 14 are radially disposed with respect to the central axis 17 of the connector and the respective pairs of gripping elements 16 are desirably arranged on opposite sides of the radial axis of the socket, in a generally parallel relationship to such radial axis.

The gripping elements 16 as shown in FIG. 2 of the '219 are provided with concave grooves 18 which are concentric about radial axis 19 of the socket and extend from the outer end extremities 20 of the gripping element a suitable distance towards the base wall 15 of the socket, typically about half way. Struts 13 are of a generally cylindrical construction at their end extremities and sized to cooperate with concave grooves 18 generally of the same diameter as the gripping elements to provide the appropriate frictional fit.

As noted above, the user of the K'NEX® construction toy is limited by the nature of hub-like connector element 10. This is the case even though there have been improvements to the design shown in the '219 patent including the ability to interconnect two modified hub elements at right angles to each other, thus allowing struts 13 to radiate from a primary hub at angles other than in the plane of the hub as shown in the patented reference.

In addition to the K'NEX® toy construction kits, there is an array of prior art for rod and hub construction toy sets which are generally designed such that receptor slots on the hubs are fixedly placed allowing only discreet angular placement of the axes of various struts attached to a given hub in relation to each other. This limitation generally dictates that a set of struts and hubs that allows the end user to construct octagonal based structures cannot be used to construct pentagonal or hexagonal based structures and vice versa.

There is a handful of construction sets that exhibit one or two degrees of angular freedom when the struts are attached to their respective hubs. In general, the prior art is restricted to the production of space structures with component parts exhibiting, at most, only two degrees of angular freedom.

The patents discussed below reflect the current state of the art of which the present inventor is aware. Reference to and discussion of these patents is intended to aide in discharging applicant's duty of candor in disclosing information that may be relevant to the examination of claims made part of to the present application. However, it is respectfully submitted that none of the patents or patent applications discussed below disclose, teach, suggest, show or otherwise render obvious, either singularly or when considered in combination, the invention described and claimed herein.

In addition to the K'NEX® structure described above, there are several other configurations in which hubs are constructed either as spheres or multi-sided polygons. Such structures are described in U.S. Pat. No. 4,129,975. Constructs disclosed by the '975 patent enable struts to emanate from slots or receptors radially in an equatorial plane and can include the ability to enable struts to emanate normal to that plane if desired.

A product competitive to the K'NEX® toy construction kit is described in U.S. Pat. No. 4,701,131 and sold under the trademark ZOME®. This product is characterized by the use of a plethora of strut receptors, some 63 in number, to increase flexibility in employing this toy by greatly increasing the number of angles that a strut can emanate from any one hub. Nevertheless, hubs, once configured, support slots in a preconfigured orientation and even with 63 such slots at any one hub, one is not able to construct a simple equilateral tetrahedron employing the ZOME® toy until “bent” struts were introduced.

U.S. Pat. No. 1,092,217 teaches the bending of strut sockets within lines of fixed longitude above or below the primary plane of the hub disk. The hub, being constructed of sheet metal, would fail in response to repeated bending resulting in ultimate breakage.

U.S. Pat. No. 2,846,809 describes a toy system in which a “ping pong ball” like hub provides a substrate for the attachment of struts using suction cups for adhesion, the limitations of which should be obvious.

U.S. Pat. No. 3,286,391 utilizes struts with “mushroom head” like configurations interconnected by semi-resilient plastic-filled spherical hubs. The semi-resilient hub material acts to grip the head of each strut enabling the strut to be held within the hub at arbitrary angles. This configuration is limited by the number of defined entry slots found within the hub and, as such, there is a discreet number of angles where the central axis lines of the struts intersect with one another at the center of the hub. When axes of the struts are not normal to the surface of the hub, the central axes of the struts do not intersect each other at a common (hub internal) vertex as they should, nor do they terminate at the center of the hub. Thus, polyhedral constructs requiring internal angles not allowed by the said affixed slot locations do not exhibit true single point vertices.

U.S. Pat. No. 3,521,421 teaches the use of individual hubs as a collection of two-leaf hinges bolted to one another with struts extending from the hinge pins of the hubs. Additional struts may be added to enhance the versatility of this kit by disconnecting hinged struts from their hubs and bolting new struts onto the hub configuration.

U.S. Pat. No. 4,069,832 teaches a kit of parts composed of fixed hubs and bent struts as well as inflexible struts with multi-hinged hubs. One using this kit is forced to employ a large number of distinguishable hub pieces and, in doing so, is unable to create a system having three degrees of angular freedom for struts radiating from their slots.

U.S. Pat. No. 4,302,900 describes a system having a spherical hub with longitudinally extending slots in which the slots radiate at arbitrary angles above and below the equatorial plane of the hub. It is noted, however, that the struts radiate only from fixed angular displacements as viewed from above or below the hub.

U.S. Pat. No. 6,846,216 provides the basis for the MAGNETIX® and similar toy systems. A user is able to attach struts to hubs through the use of magnets. While large or complex structures may be created with these magnetic based systems, the resulting structures are generally fragile.

U.S. Pat. Nos. 2,667,479, 2,303,294, 3,077,282, 3,243,838 and 5,172,534 teach, in one form or another, the use of hinge pins or pintles to hinge subparts for rotation about a primary hinge axis. For example, the '294 patent allows lateral entrance of the hinge pin into the surrounding hinge knuckle via a gap cut in the side of a second hinge leafs knuckle. The opening of this gap is slightly narrower than the diameter of the hinge pin, requiring deformation of the knuckles during assembly. In this fashion, the hinge element of the second body is releasable held by the hinge element of the first. The '480 patent discloses a similar narrow-throated radial axis noting that repeated insertion and removal of the hinge pin into its gripping member is required. The '282 patent teaches a pintle captive to a first hinge member and held by a second member along the hinge axis at the end of the pintle. As to the '282 patent, the pintle is a sphere captive to one member held in place by two axially located concave knuckles captive to the second member. The '838 patent describes the use of a small cylinder as its pintle with concave ends held on each end by convex members, such as spheres. Finally, the '534 patent employs hinge knuckles as disks with convex portions that effectively grip the disk-shaped pintle, the pintle having a concave structure on each axial end. In each instance, the hinges of the prior art are created by deforming the hinge material while the members snap together.

The K'NEX® toy kit as described above has been modified over time enabling, for example, one to interconnect two modified hubs at right angles to each other thus allowing struts to radiate from a primary hub at an angle other than in the plane of the hub, the angles in which the struts emanate from the hub being limited to specific values configured within the hub when fabricated.

It is thus an object of the present invention to provide a connector element and particularly one for use for creating a space structure, such as a toy system of the prior art which can be articulated along one or more orthogonal axes allowing struts to emanate therefrom allowing the construction of a multitude of new spatial constructs generally heretofore unavailable.

It is a further object of the present invention to provide a connector element for a space structure, such as the type shown in the '219 patent having the ability to enable strut elements to radiate in a number of diverse and selectable angles to one another thus enhancing the geometric shapes and configurations achievable by the prior art.

These and further objects will be more readily apparent when considering the following disclosure and appended claims.

### SUMMARY OF THE INVENTION

The present invention is directed to a connector element fox a space structure as well as a kit of parts to produce such a structure ideally suited to a construction toy of the type comprising a plurality of hub-like connector elements and a plurality of structural elements adapted to be removably engaged with the connector elements. The connector elements are comprised of first, second or more subparts having zero, one or more strut-receiving sockets emanating from each of the subparts, the subparts being rotatable with respect to one another along one or multiple common axis (axes).

### BRIEF DESCRIPTION OF THE FIGURES

FIG. 1 is an elevational view, partly in section, of a hub-like connector element constructed according to the teachings of U.S. Pat. No. 5,061,219 representing prior art to which the present invention is an improvement.

FIG. 2 is an enlarged fragmentary, perspective view of a portion of the connector element of FIG. 1 illustrating an opposed pail of gripping arms forming a socket for the reception of a structural element and, as such, further represents an example of the prior art.

FIGS. 3A and 3B are hub subparts shown in elevational views illustrating various components thereof.

FIG. 4 is an elevational view of the subparts of FIGS. 3A and 3B joined together

FIGS. 5A and 5B are cross-sectional views taken along lines 5-5 of FIG. 3A and 6-6 of FIG. 3B, respectively.

FIG. 5C is a cross-sectional view of an alternative embodiment to that shown in FIG. 5A.

FIG. 5D is a cross-sectional view of the elements of 5A and 5B shown joined to facilitate rotation with respect to one another FIGS. 6A-6D are elevational views of alternative hub elements as alternatives to those shown in FIGS. 3A and 3B.

FIG. 7A is an elevational view of a present hub element and stand-alone strut receiving element for engagement along the hinge of said hub element.

FIG. 7B is an elevational view of another stand-alone strut receiving element as an alternative to the corresponding element shown in FIG. 7A.

FIG. 8 is a crossectional view of hub/strut receiving elements of the type depicted in FIG. 7A joined to facilitate rotation with respect to one another.

FIGS. 9A, 9B and 9C are elevational views showing the creation of a split hub embodiment of the present invention.

FIG. 10A is an elevational view of a hub element of the present invention created by the joinder of two split hub elements of the type depicted in FIG. 9C.

FIG. 10B is a crossectional view of the hub element of FIG. 10A taken along line 105-105 thereof.

FIG. 10C depicts a side view of a split clip for use herein.

FIG. 10D is yet another embodiment of a strut receiving element made part of a split clip for use herein.

FIGS. 11A and 11B are elevational views of yet other embodiments of hub elements having sliders for receipt of stand-alone slot receiving elements.

FIG. 11C is an elevational view of a stand-alone slot receiving element for use in the hubs of FIGS. 11A and 11B.

FIGS. 11D and 11E are crossectional views of the elements of FIGS. 11B and 11C, taken along lines 135-135 and 136-136, respectively.

FIG. 11F is an elevational view of the hub of FIG. 11A having joined with a stand-alone slot receiving element of the type shown in FIG. 11C.

FIG. 11G is an elevational view of a composite hub element as a further embodiment hereof.

FIG. 12A is a side view of a hinge clip constructed of two subparts affixed to each other by inclusion of a separable hinge.

FIGS. 12B and 12C are front and back views of subparts of the hinge clip of FIG. 12A showing knuckles and hinge cylinder similar to that depicted in FIG. 10B.

FIG. 13 is an elevational view of a hub element of the present invention created by the joinder of a combination of split and slider hub elements removably fixed together through the use of a hinge clip.

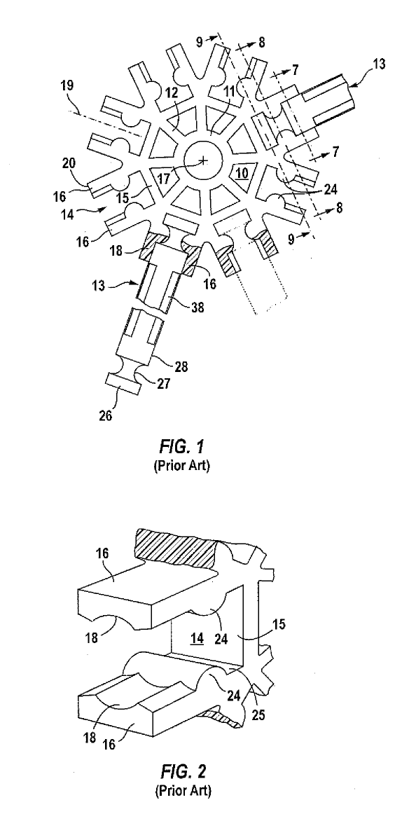

### DETAILED DESCRIPTION OF THE INVENTION

Novel features which are characteristic of the invention, as to organization and method of operation, together with further objects and advantages thereof will be better understood from the following description considered in connection with the accompanying drawings, in which preferred embodiments in the invention are illustrated by way of example. It is to be expressly understood, however, that the drawings are for illustration description only and are not intended as definitions of the limits of the invention. The various features of novelty which characterize the invention are recited with particularity in the claims.

There has been broadly outlined the more important features of the invention in the summary above in order that the detailed description which follows may be better understood, and in order that the present contribution to the art may be appreciated. There are, of course, additional features of the invention that will be described hereinafter and which will form additional subject matter of the claims appended hereto. Those skilled in the art will appreciate that the conception upon which this disclosure is based readily may be utilized as a basis for the designing of other structures, methods and systems for carrying out the several purposes of the present invention. It is important, therefore, that the claims be regarded as including such equivalent constructions insofar as they do not depart from the spirit and scope of the present invention.

Certain terminology and derivations thereof may be used in the following description for convenience and reference only, and will not be limiting. For example, words such as “upward,” “downward,” “left,” and “right” refer to directions in the drawings to which reference is made unless otherwise stated. Similarly, words such as “inward” and “outward” refer to directions toward and away from, respectively, the geometric center of a device or area and designated parts thereof. The plane of the hub refers to the plane the generally disc-like geometry of a connecting element of this invention resides in as it may be when lying on a sheet or table (e.g. unfolded, flat). Reference in the singular tense include the plural and vice versa, unless otherwise noted.

The invention relates to a class of construction toys principally made up of sets of rods (struts) and connectors (hubs). More specifically, this invention relates to the assemblage of the elements of this invention, resulting in the formation of space structures for entertainment or education. These space structures may take on the form of simple to complex polyhedral, as well as any of a wide range of spatial structures (buildings, vehicles, atomic lattice structures, civil engineering models, etc).

Generally provided as a kit, the invention consists of hubs and struts. The struts are generally fastened to each other through the use of connecting elements, generally referred to as hubs. In the context of polyhedral or space structures, the struts comprise the edges of said structures, and the connectors or hubs make up the vertices of the structures. In kit form, other elements may be provided, such as planar surfaces, mechanical elements, and so forth.

As embodied, generally rigid or semi-rigid struts have a profile generally similar to that of elongated cylinders, where the axial length of the cylinder is proportionally longer than that of the cross section or diameter of the cylinder. The cross section of the strut is not specifically circular, but generally has a perimeter contained within a circular or oval envelope—with the understanding that this may include cross-sections having square, rectangular, or other polygonal shape, for example, an “x” shaped cross section.

In the invention, the hubs generally have some number of regions to which the struts are mated to the hubs. In the specific case and embodiment of the invention detailed below, that portion of the hub attaching the strut to the hub is often referred to and constructed as a slot or socket, but more generally, could be any of a range of attaching mechanisms. In the more specific case of the preferred embodiment, this attaching mechanism utilizes strut gripping arms of the form described by U.S. Pat. No. 5,137,486, the basis for the line of toys commonly known as K'NEX®. However, it is the intent of this invention that the attaching mechanism not be limited to the specific mechanical design detailed in that patent or detailed in the preferred embodiment described below, but could be of a range of designs, some of which have been previously disclosed in prior patents, such as for Tinkertoy®, first described by U.S. Pat. No. 1,113,371 utilizing a compression/friction grip.

Regarding the hubs, while it is the case that many of the angularly fixed hub and strut space structure building sets disclosed in prior art can build a myriad array of space structures, those designs are generally limited to space structures with discrete, fixed angular strut orientations such as 30°, 45°, 60° and 90° to each other.

Allowing for variation in strut design and the design of the strut to hub mating configuration, the essence of this invention is that of the provision allowing continuous range of position and relative angular orientation of the struts attached to a given hub employed in some user defined polyhedral or other space construct. This mechanism is provided in this invention by the inclusion of three orthogonal rotational axes within the construct of the hub elements, whereby the strut receiving slots of the hub can rotate about those axes.

The hub mechanism of this invention allows that the user may employ identical hub elements of this invention in differing configurations to place strut elements at differing angular orientations (to each other) in a given structure, or to re-employ these elements in an altogether different polyhedral space structure at differing angular orientations at some later time.

Examples of differing angles that may be required by a user constructing polyhedral structures follow, many of which cannot be assembled using existing art.

In constructing Platonic and Archimedean solids, often of importance is the dihedral angle (the angle between two adjacent surfaces of the solid). These angles include 70.53° for the tetrahedron, 116.57° for the dodecahedron, and 138.19° between the hexagonal surfaces of the truncated icosahedrons, this latter solid often known as a buckyball after Buckminster Fuller, the angles of which define the soccer ball, as well as that of C₆₀, the carbon molecule fullerene. The dodecahedron consists of pentagons, with struts meeting at 108°, not simple multiples of 30° or 45° The inner angles of the rhombic faces of the rhombic dodecahedron are 70.53° and 109.47°, with a dihedral angle of 120° The dihedral angles between the hexagonal surfaces comprising carbon nanotubes designated in form by (n,m) are 150°, 152.3°, 158.8° for m=0, n=12, 13 and 17, respectively. For other values of m and n, the required dihedral angles are different.

In a more complex example, the 4V icosahedral dome (one of many geodesic domes), the angles of the supporting struts of the structure relative to some plane tangent to the surface of the dome at the intersection of the struts include the following values: 7.27°, 8.47°, 8.49°, 8.59°, 9.00°, 9.35° The angles between two given struts attached to the hubs within this same geodesic dome require an even larger range of specific values: 54.34°, 57.52°, 58.72°, 59.92°, 60.16°, 62.55°, 63.68°, 71.32°, values that can easily be accommodated for by the mechanics of this invention.

Fortunately, for the casual user, knowledge of these values is generally not required. Users playing with the magnetic ball and strut toy, a space construction kit with no pre-set angular strut orientations, do not know the inner angular values when they construct an octahedron; the relative angular placement of the struts in an octahedron are forced by set geometric constraints. By providing this flexibility in angular strut relationships while simultaneously providing a structurally robust system of connectors, it should be clear the advantages the invention disclosed here provide over prior inventions of similar art.

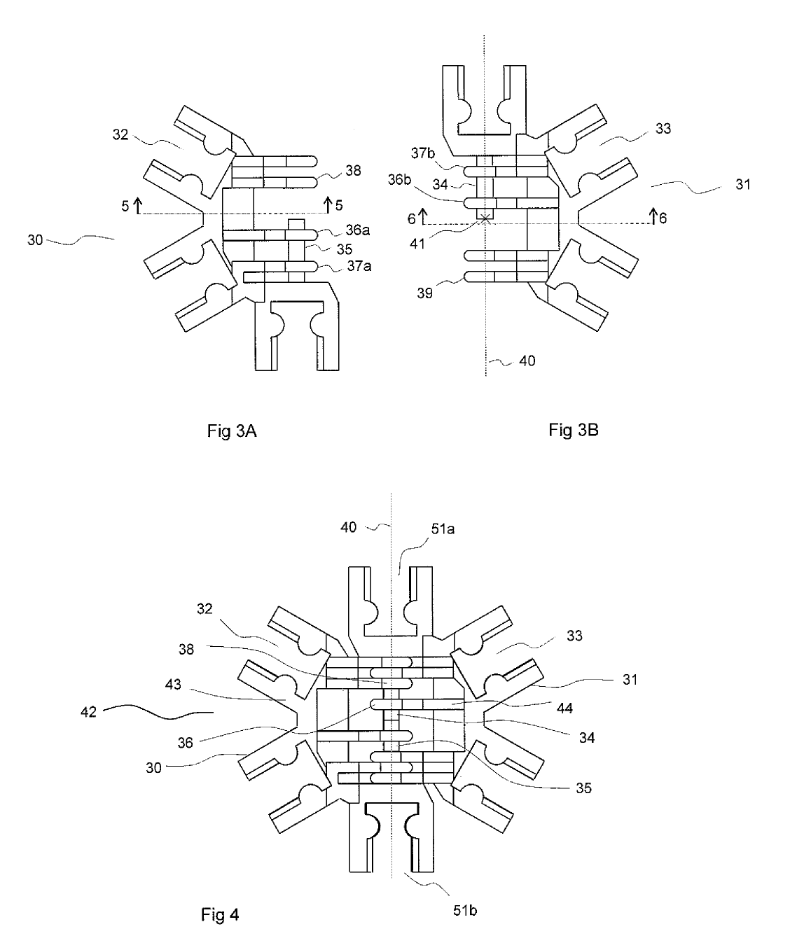

Turning to FIGS. 3A and 3B, what is shown is a primary connector element which can be used with, for example, the K'NEX® type of toy construction system. It should be remembered, however, that the fundamental concepts proposed herein extend well beyond a K'NEX®-type system noting that different strut receiving sockets can be configured to adapt the present invention to a more universal application.

Subparts 30 and 31 shown in FIGS. 3A and 3B, respectively, are composed of strut receiving slots 32 and 33 emanating from the subparts configured to receive appropriate struts therein and hinge elements 34 through 39. In this embodiment, pintles 34 and 35 are shown noting that in FIG. 3B, axis 40 is illustrated as passing directly through and aligning with pintle 34. Hinge pintles 34 and 35 are held captive by hinge knuckles 36a, 37a and 36b, 37b, respectively, though may otherwise be rotatable or releasable within those knuckles in alternate embodiments envisioned by this invention. Open hinge knuckles 38 and 39 are shown in FIG. 3A.

It should be readily apparent that subparts 30 and 31 differ from one another only insofar as the same subparts are translated 180° about upward axis 41 perpendicular to the page in this figure. In performing this 180° translation, subparts 30 and 31 can be releasably joined to create the composite connector element shown in FIG. 4

The rotational symmetry of the hub subparts is an advantage in that there is a reduction in the number of differing connector hub subparts required in a kit form of the invention, as well as a reduction in the number of differing subparts in the user's design of various constructs therefrom. While the preferred embodiment of the invention is that of a symmetric design, the spirit and scope of the invention includes non-symmetric designs as well. Further, the intent of this invention includes those designs where the hub's subparts are not releasably fixed to each other, but simply fixed to each other.

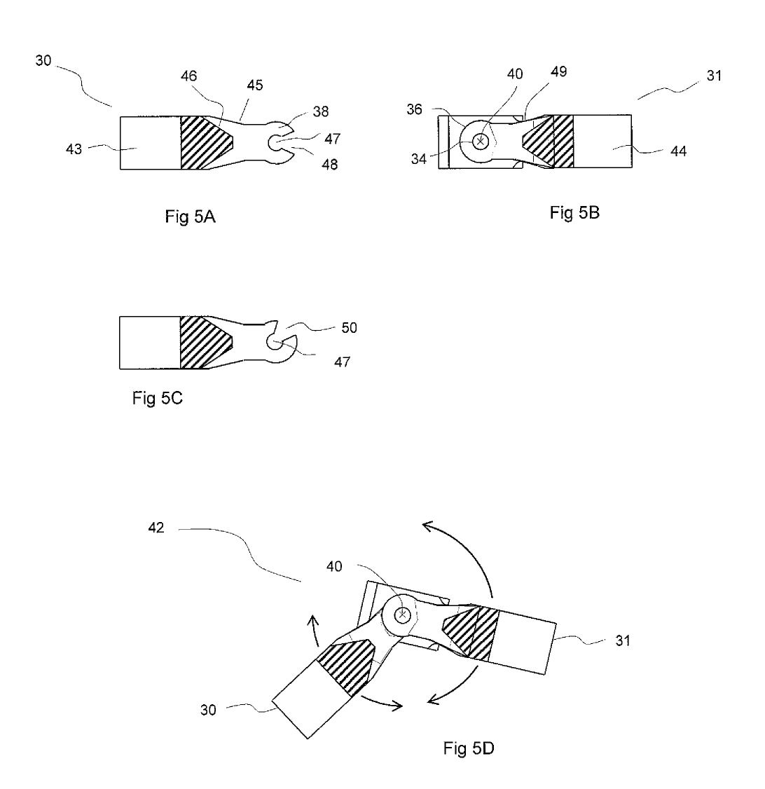

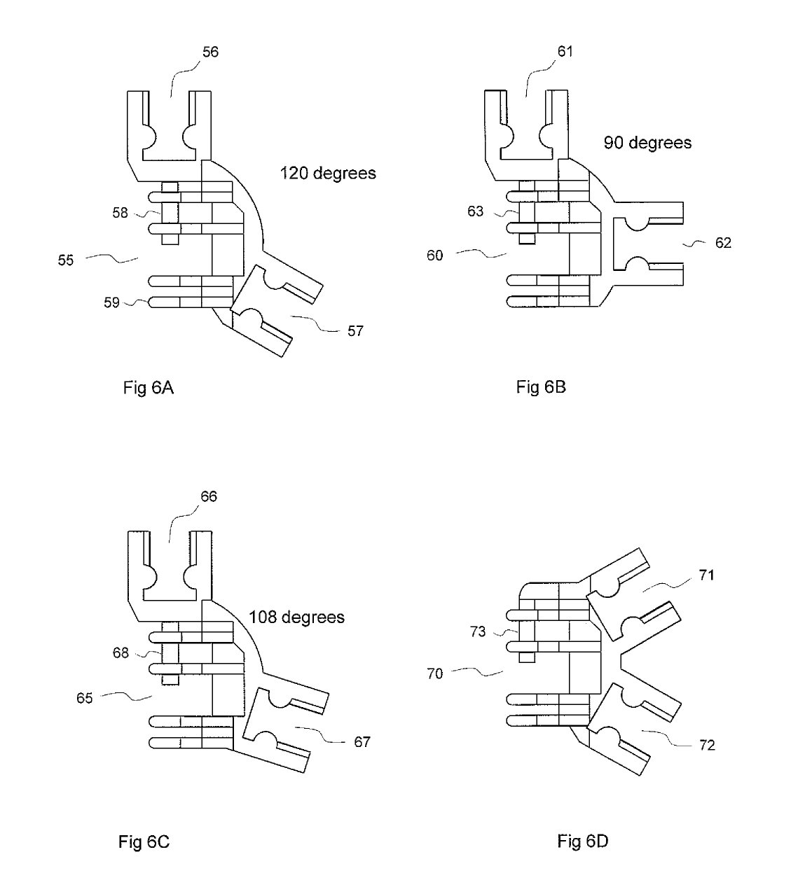

The geometry of these various subparts can be more readily appreciated in considering FIGS. 5A and 5B produced by taking cross sections along 5-5 and 6-6, FIGS. 3A and 3B, respectively.

As noted in reference to FIG. 4, once subparts 30 and 31 are joined, pintles 34 and 35 align along axis 40. In doing so, it is noted that pintle 34 is frictionally fit within hinge cylinder 47, viewed in FIG. 5A, of the hinge knuckle 38. Similarly, pintle 35 is frictionally fit within the hinge cylinder of hinge knuckle 39. Subparts 30 and 31 are further caused to be rotatable with respect to one another along axis 40 by providing knuckles 38 and 39, partially encompassing pintle 34 and 35 respectively, by providing complimentary hinge cylinders for their passage therethrough.

It should further be appreciated that first subpart 30 and second subpart 31 rotate with respect to one another by virtue of the hinge alignment of pintles 34 and 35 as the first subpart catches the pintle of the second subpart and the second subpart captures the pintle of the first subpart. This capture is accommodated via snapping the pintle 34 into the hinge cylinder 47 via the constricted lateral opening 48, and similarly by snapping pintle 35 into the respective opening of hinge knuckle 39.

In order to enable subparts 30 and 31 to achieve maximum rotational range, subparts are preferably beveled. This is depicted in FIG. 5A noting beveled region 45 extends from knuckle 38 as the subpart extends to body portion 43, and in noting the beveled region 46 as part of the body portion 43. As to FIG. 5B, beveled portion 49 extends from knuckle portion 36 to body portion 44. Complementary beveling is found on mating subparts. While the beveling is not a necessity of this invention, this attribute further increases the utility of the invention by allowing the subparts 30 and 31 to rotate about the other across greater rotational range.

As an alternative to the preferred embodiment, it is noted that lateral opening 48 to the hinge cylinder 47 shown in FIG. 5A can extend at alternate angles other than the plane of the hub, as shown as hinge cylinder opening 50 in FIG. 5C.

In reference to FIG. 5D, cross-sectional views are provided to illustrate subparts 30 and 31 joined to each other, where 30 and 31 are rotating with respect to the other about axis 40, perpendicular to the page in this view.

It must be appreciated that although FIGS. 4, 5A, 5B depict the present basic connector element or hub having two subparts radially supporting strut receiving sockets the geometry of these hinges can be configured in virtually any typical hinge design—ball and socket, free pintle, axial pintle to hinge cylinder insertion, and so forth, most of which are prior art hinges and have been disclosed in prior hinge patents. Additionally, while there are advantages in use of a hinge constructed of two independent pintle elements 34 and 35, the scope of this invention includes the use of a single pintle based design.

It must be appreciated that although FIG. 4 depicts the present basic connector element or hub having two subparts radially supporting six strut receiving sockets including primary sockets 51a and 51b along axis 40, the geometry of these sockets can be configured in virtually any angular relationship while remaining within the spirit and scope of the present invention. Further, it must be also appreciated that the number of strut receiving sockets on a given hub or subpart is not set as depicted in the figures or description, but may be more or less in quantity as well. As illustrative, reference is made to FIG. 6A through 6D.

FIG. 6A depicts subpart 55 having but two receiving sockets 56 and 57 spaced 120° from one another. Socket 56 is considered a primary socket extending directly from pintle 63. Knuckles 59 are included to capture a corresponding pintle of a second subpart in order to create the appropriate hinge for rotation.

FIG. 6B depicts subpart 60 having primary socket 61 and second socket 62 positioned 90° from one another. Again, primary socket 61 extends directly above pintle 63. FIG. 6C is similar to FIG. 6A, however, in this instance, subpart 65 includes primary socket 66 aligned with pintle 68 is but 108° from second socket 67.

FIG. 6D illustrates subpart 70 in which sockets 71 and 72 are 60° apart with no primary socket aligned with pintle 73. Again, the embodiment shown in FIG. 6A through 6D are simply illustrative of the myriad of possibilities contemplated by the present invention in creating a wide range of connector elements for producing a myriad of space structures unachievable by the prior art.

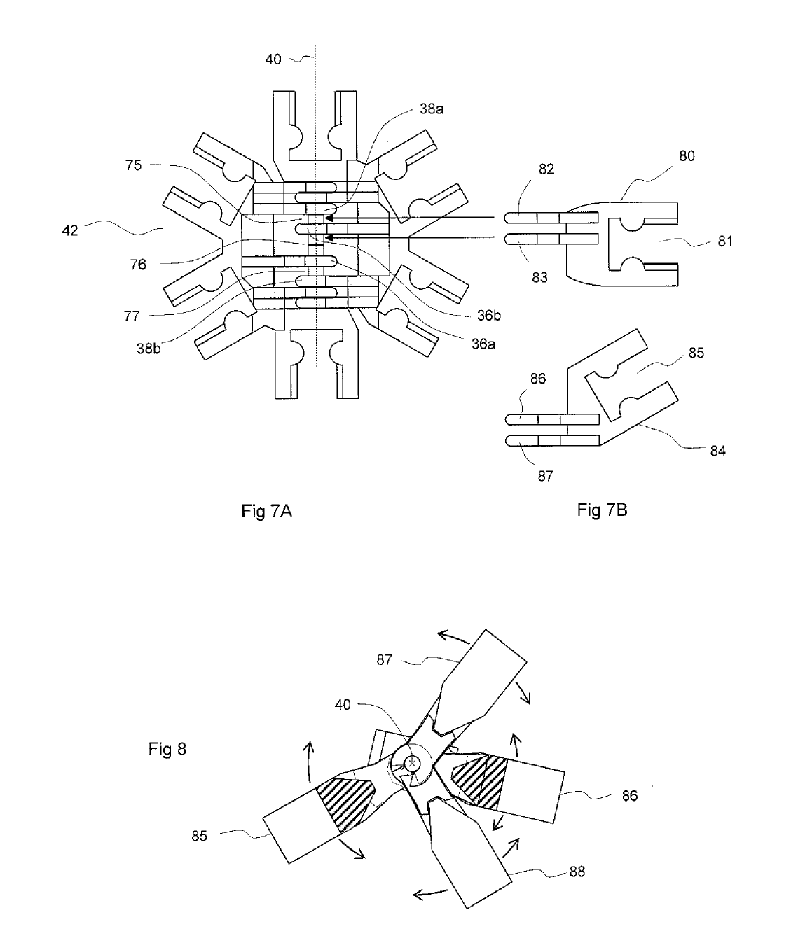

As a further enhancement to the present invention, reference is made to FIGS. 7A and 7B. FIG. 7A has replicated hub 42 of FIG. 4 showing the various socket receiving elements, as well as pintles and knuckles creating the appropriate hinge for rotation of the two subparts. In so constructing connector element 42, gaps 75, 76 and 77 exist between knuckles 36a, 36b, 38a and 38b. This “free space” along the pintles enables yet another socket receiving element 80 of FIG. 7B to releasably connect to connector 42 by snap fitting knuckles 82 and 83 onto the appropriate free space on the pintle elements. In fact, multiple socket receiving elements can be so applied. As an illustration, reference is made to FIG. 8 showing hub subparts 85, 86, 87 and 88 and their respective socket receiving elements all independently rotatable about the hinge axis 40. For illustrative clarity 85 and 86 are cross-sectional views of 30 and 31 taken along 5-5 and 6-6, FIGS. 3A and 3B, respectively and subparts 87 and 88 are additionally attached subparts similar to 80 of FIG. 7B.

As yet a further embodiment, reference is made to FIG. 7B noting that strut receiving socket 85 can be positioned angularly to knuckles 86 and 87 to again enhance the flexibility of the present invention. Though not shown, this invention also envisions multiple strut receiving sockets embodied on a single knuckle pair so as to further increase flexibility of function.

To this point, the invention has been described focusing primarily upon connector element 42 (FIG. 4) whereby two pintle elements of two subparts (e.g. of FIG. 3, FIG. 6) are aligned along a common axis 40 in creating a hinge enabling the rotation of these subparts to create a wide variety of space structures. To demonstrate additional advantage of the split pintle design of this invention, further function based on splitting the entire hub is illustrated.

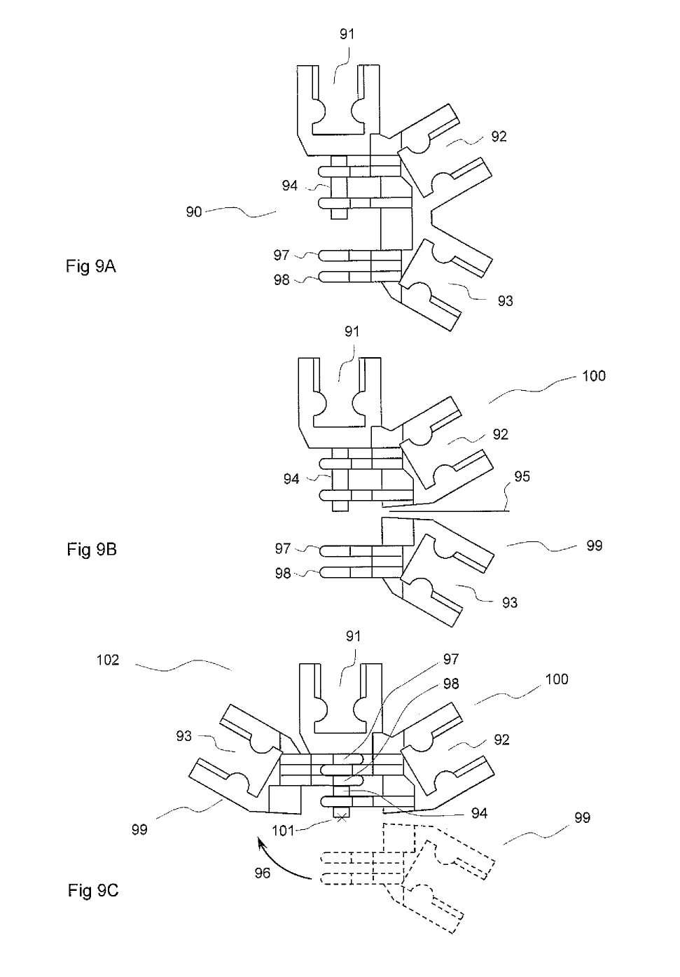

The subparts of this advantageous embodiment are shown in FIG. 9C although FIGS. 9A and 9B depict how the construct of FIG. 9C was created. Specifically, subpart 90 is shown being virtually identical to either the subpart of FIG. 3A or the subpart of FIG. 3B. In this regard, strut receiving elements 91, 92 and 93 emanate from this subpart and includes pintle 94 emanating directly beneath primary strut receiving element 91. Beneath pintle 94 are hinge knuckles 97 and 98 which, in previous embodiments, were taught to create the appropriate cylindrical openings for snapping onto appropriate pintles of other subparts. However, in this instance, subpart 90 is dissected along cut line 95 (FIG. 9B) separating strut receiving socket 93 and its corresponding knuckles 97 and 98 from the remainder of subpart 90 forming new subparts, 99, 100. In turning to FIG. 9C, subpart 99 embracing strut receiving socket 93 is rotated about axis 101 (perpendicular to the page) as shown by arrow 96 depicted in phantom such that knuckles 97 and 98 now snap fit onto pintle 94 as shown. Thus, two new subparts, a first 99 embracing strut receiving socket 93 and the second 100 embracing strut receiving sockets 91 and 92 rotate about single pintle 94, comprising a new connector configuration, 102.

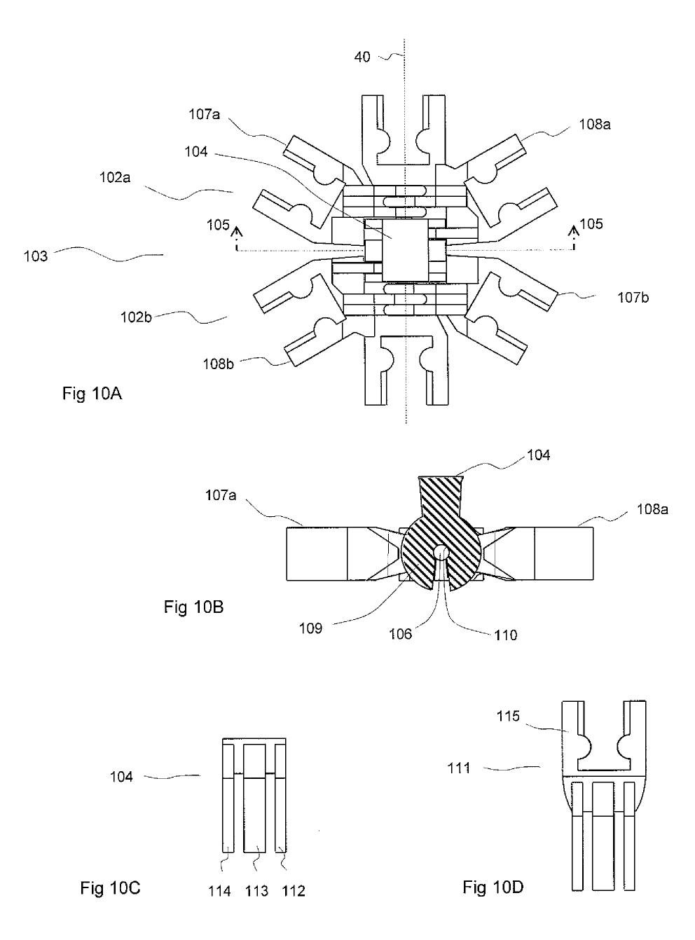

Turning next to FIGS. 10A and 10B, compound subpart 102 of FIG. 9 is shown joined to an identical such compound subpart which, as a whole, is identified as 103, the split hub. Split hub 103 is composed of compound subpart 102a and its 180 degree rotationally translated duplicate 102b attached to one another through the use of split clip 104. As a preferred embodiment, split clip 104 enables split hub subparts 102a and 102b to further rotate with regard to one another about axis 40.

This can be more readily visualized by reference to FIG. 10B, taken at cross-section 105-105, showing the hinge knuckle 109 and hinge cylinder 110 of the split clip 104 releasably fixed to pintle 106 enabling multiple individual subparts 107a-b, 108a-b of FIG. 10A to all independently rotate in relation to one another while being held removably captive to each other. As a side view, FIG. 10C further illustrates the split clip 104 and its hinge knuckle elements 112, 113 and 114 designed to capture pintles of, for example, split hub subparts 102a and 102b (FIG. 10A) as described above.

To further enhance the utility of the present invention, the split clip described above and depicted in FIGS. 10A, 10B and 10C can further be provided with its own strut receiving socket. In this regard, reference is made to FIG. 10D showing split clip 111 having hinge knuckles but further having strut receiving socket 115 to enable a suitable strut to extend in an axis rotatable about and perpendicular to axis 40. Although not shown, strut receiving socket 115 could also be configured in a form with multiple sockets as well as one or more sockets extending at an angle other than perpendicular to the axis 40.

This invention also envisions alternate embodiments of subpart 111, such as but not limited to differing hinge knuckle arrangements providing for the simultaneous employment of multiple split clips on a single split hinge hub, such as through the removal of either of element 113 or elements 112 and 114.

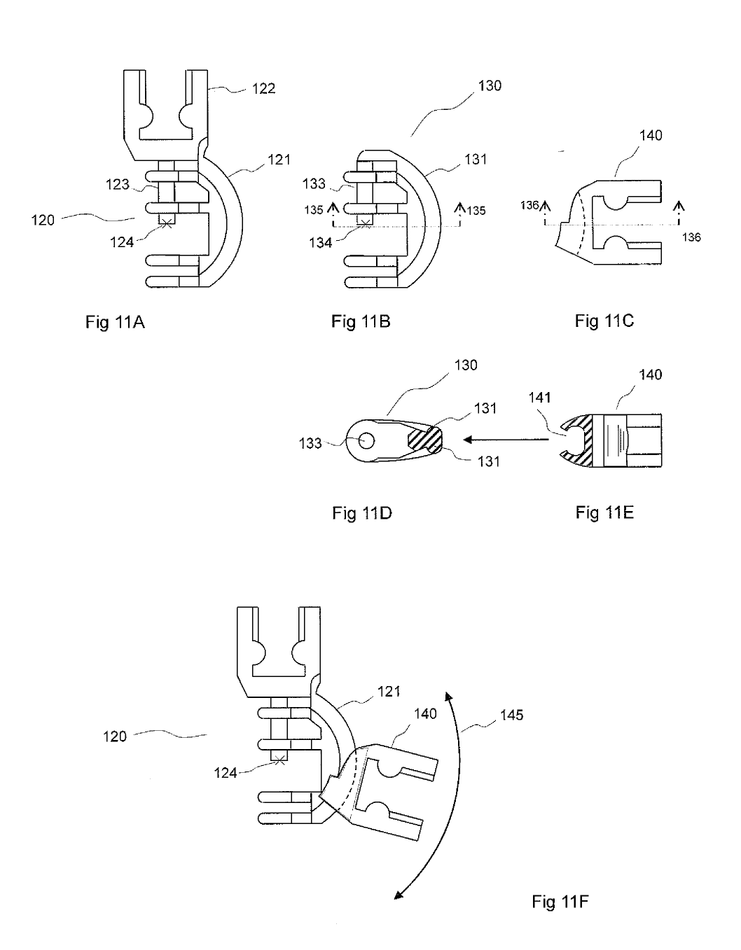

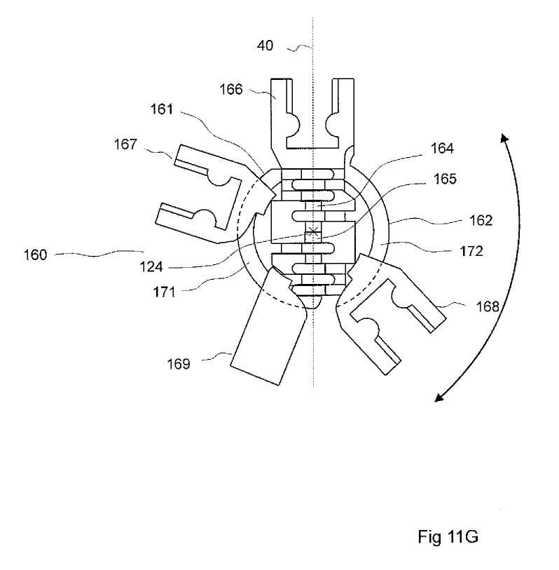

The utility of the present invention can be extended yet further and, with respect thereto, reference is made to FIGS. 11A through 11F.

As a further enhancement to the connector elements described previously, FIG. 11A shows slider hub subpart 120 having pintle 123 and primary strut receiving socket 122 aligned therewith. In addition, curved substrate 121 is shown in the form of a semi-toroidal contour element. FIG. 11B depicts a modification of the connector element subpart 130 devoid of any strut receiving socket whatsoever. Again, however, curved substrate 131 is shown as well as pintle 133. There are obviously other modifications of hub subparts which can be employed while embodying the semi-toroidal contour of these figures.

In use, a strut receiving element, the slider socket 140 of FIG. 11C is configured to releasably join curved substrates 121 and 131 which is slidable therealong in order to provide a strut receiving socket rotatable about axes 124, 134, perpendicular to the sheet of drawings. To further appreciate the interface between the slider socket and a curved substrate, reference is made to FIGS. 11D and 11E which show cross section 135-135 of subpart 130 and cross section 136-136 of slider socket 140, respectively. As is quite apparent, open contour 141 of slider socket 140 is configured to mate with curved substrate 131. In a similar fashion, this mating can be performed with subparts 120 and 140, the joinder of which being shown in FIG. 11F. Again, slider socket 140 can translate along curved substrate 121 in the direction of arrows 145 about axis 124 perpendicular to the page.

Shown in FIG. 11G, slider hub 160 can be composed of subparts 161 and 162 where pintles 164 and 165 align along axis 40 for hinged rotation about that axis. Primary strut receiving socket 166 remains aligned along these pintles while various slider sockets 167, 168 and 169 can be caused to slide along curved substrates 171 and 172 as discussed previously, providing constant radius angular translation about axis 124. So to provide further advantage, slider socket 169 is illustrated in an alternate embodiment, one of many alternatives within the intent of this invention.

It should be obvious the slider hub may readily be constructed as a split hub, where for example, slider subparts 120 and 130 may be fashioned into further subparts in the manner of hub subpart 90, FIG. 9A being comprised of two split-hub subparts 99 and 100, yet further increasing the utility of the invention described herein.

It should be apparent that the invention as described thus far allows strut receiving sockets attached to the hub to be translated along a continuous range of values about the origin [center] of the hub about two orthogonal axes. While generally any spherical polar coordinate can be defined by a selection of two angles about two orthogonal axes, it may be apparent that mechanical limitations of the invention as described up to this point preclude some angular values from being realized. Following is a description of further enhancements to the utility of the invention allowing struts emanating from the connecting hub to be set to any polar coordinate. This is accomplished by providing mechanisms enabling strut receiving sockets to revolve about a third orthogonal axis.

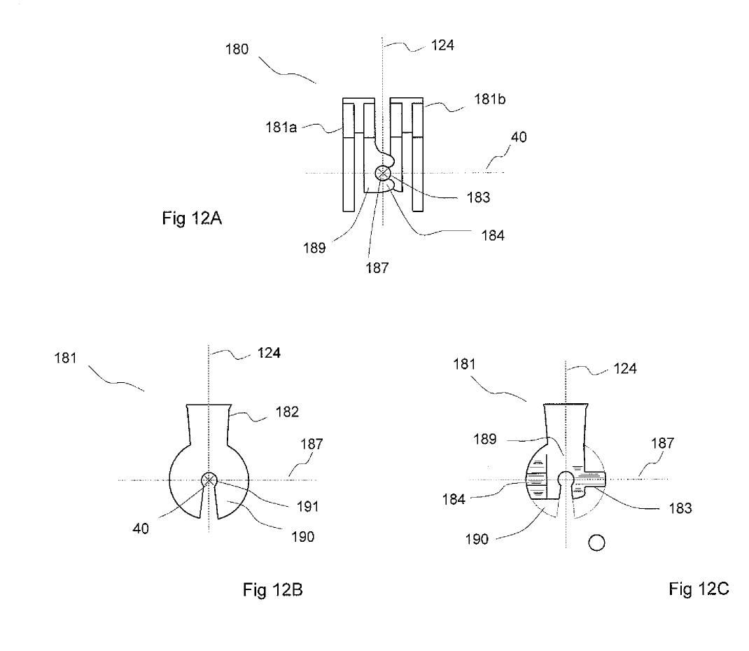

To further enhance the utility of the invention, the split clip described above and depicted in FIGS. 10A-10C can further be provided with the addition of a hinge allowing portions of the clip to rotate about an axis orthogonal to both axis 40 of FIG. 4 and axis 124 of FIG. 11F previously described. In this regard, reference is made to FIG. 12A. FIG. 12A should be viewed in comparison to FIG. 10C, where a hinge clip 180 of 12A is constructed of two subparts 181a and 181b, separably fixed to each other by the inclusion of a separable hinge co-located to axis 187, orthogonal to axes 40 and 124. The hinge is comprised of pintle 183 removably enclasped by hinge knuckle 184.

As it must be obvious to anyone in the art, construction of the hinge can take many forms, captive or non-captive pintle, ball and socket hinge, symmetric or non-symmetric design, and so forth. In this preferred embodiment, subparts 181a and 181b of the hinge clip are identical in form, one translated 180 degrees about axis 124 relative to the other, with symmetric hinge elements 183 and 184 releasably fixing to each other.

To further appreciate the design of the subparts comprising the hinge clip, reference is made to FIGS. 12B and 12C. 12B shows hinge knuckle 190 and hinge cylinder 191 of form similar to 109 and 110 of FIG. 10B, designed to releasably capture pintles of the split hub and split slider hub enabling subparts of those connector hubs to all independently rotate in relation to one another while being held removably captive to each other FIG. 12C highlights element 189 of the hinge-clip, detailing the hinge pintle 183 and the hinge knuckle 184. Element 190 is dimmed in FIG. 12C to assist the viewer in understanding the design. In this embodiment, symmetric design provides that the hinge knuckle 184 of each subparts 181 releasably clasp the pintle 183 of the other, where the axes of the two constructed hinges are aligned on axis 187. Overall, the hinge-clip provides the advantage of a mechanism to allow multiple strut receiving slots a third axis of rotation about the connector hub.

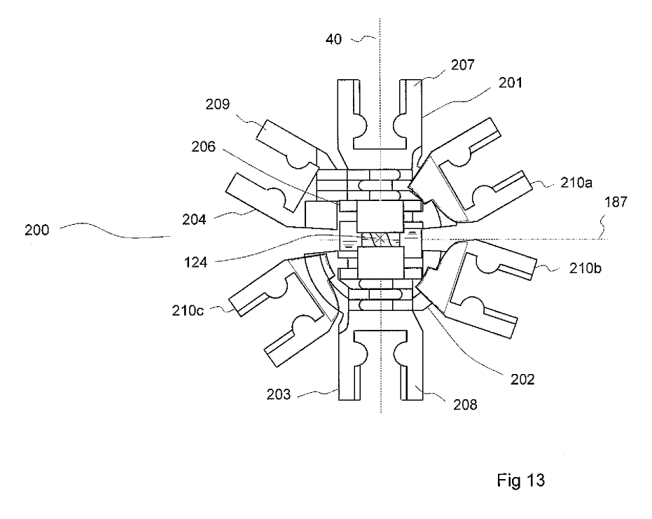

Finally, as shown in FIG. 13, hub 200 can be composed of subparts 201, 202, 203 and 204, a combination of split-hub elements and split slider hub elements releasably fixed to the other by their respective hinge elements aligned with axis 40, and by the use of the hinge clip 206, the latter including a hinge element aligned with axis 187. Fixed to subparts 201, 203 and 204 are strut receiving sockets 207, 208 and 209, respectively. Additionally, subparts 210a-c are slider sockets releasably fixed to subparts 201, 202 and 203, which by implementation of this invention can revolve about axis 124 independent of additional angular translation caused by the folding of the hub subparts to which they are attached about axes 40 and 187.

Although the various elements of the present invention have been disclosed individually, it should be readily apparent to anyone skilled in this art that the combination of subparts in producing a space structure from the disclosed kit of parts is almost limitless. The incorporation of a curved substrate such as semi-toroidal elements 121 and 131 of FIGS. 11A and 11B can be used with any of the embodiments disclosed previously. For example, the split hub element 103 (FIGS. 10A-10C) can be employed with connector 160 of FIG. 11G to increase the present invention's utility, with or without the use of the hinge clip. In the latter fashion, the connector hub provides the rotation of the strut receiving slots about any or all of three orthogonal axes. Subparts of hub elements can be configured with or without strut receiving sockets, be they primary sockets or otherwise. Subparts can be joined to create a hinge on a single pintle without joining multiple pintles along the common axis.

The above disclosure is sufficient to enable one of ordinary skill in the art to practice the invention, and provides the best of mode practicing the invention presently contemplated by the inventor. While there is provided herein a full and complete disclosure of the preferred embodiments of the invention, it is not desired to limit the invention to the exact construction, dimensions, relationships, or operations as described. Various modifications, alternative constructions, changes and equivalents will readily occur to those skilled in the art and may be employed as suitable, without departing from the true spirit and scope of the invention. Such changes might involve alternative materials, components, structural arrangements, sizes, shapes, forms, functions, operational features or the like.

Therefore, the above description and illustration should not be considered as limiting the scope of the invention, which is defined by the appended claims.

What is claimed is:

1. A connector element for a space structure of the type utilizing a plurality of struts, said connector element comprising first and second subparts, at least one strut receiving element having a strut-receiving socket emanating from each of said subparts, said subparts being rotatable with respect to one another along a common axis.

2. The connector element of claim 1 wherein a plurality of strut-receiving elements radiate from each of said subparts wherein the longitudinal axis of struts attached therewith intersect a central point of said connector element.

3. The connector element of claim 1 wherein said subparts are attached to one another by use of a hinge.

4. The connector element of claim 3 wherein each of said subparts comprises a pintle, wherein said first subpart rotatably and releasably captures the pintle of said second subpart and said second subpart captures the pintle of said first subpart.

5. The connector element of claim 4 wherein the pintle of said first subpart and the pintle of said second subpart align with one another along a common axis when said subparts are attached to one another.

6. The connector element of claim 4 wherein at least one hinge knuckle is provided in said first subpart for capturing the pintle of said second subpart and at least one hinge knuckle is provided in said second subpart for capturing the pintle of said first subpart.

7. The connector element of claim 6 wherein said subparts are beveled from said hinge knuckles as said subparts extend therefrom.

8. The connector element of claim 1 wherein said first and second subparts are identical to one another.

9. The connector element of claim 3 further comprising at least one strut receiving element releasably attachable to said connector element.

10. The connector element of claim 9 wherein at least one strut receiving element is releasably attachable to said pintle and rotatable about said pintle independently of said first and second subparts.

11. The connector element of claim 1 where said strut receiving socket comprise outwardly extending gripping arms parallel to longitudinal axis of said attached strut adapted to releasably receive said strut therewith.

12. The connector element of claim 11 wherein said gripping arms provide for lateral insertion of the said strut therewith, and include concave recesses extending in a direction parallel to the axis of said gripping arms and said struts to confine said strut from lateral movement relative to said gripping arms.

13. The connector element of claim 11 wherein said gripping arms comprise at least one locking projection to mate to a corresponding annular groove configured within said strut coaxial to the strut's longitudinal axis to restrain its axial release.

14. The connector element of claim 1 further comprising at least one slider hub subpart providing a curved substrate emanating from said slider hub subpart and at least one strut receiving element removably attached to said curved substrate.

15. The connector element of claim 14 wherein said curved substrate is in the form of a semi-toroidal contour wherein the axis of which is orthogonal to said common axis about which said subparts are rotatable with respect to one another.

16. The connector element of claim 14 wherein said strut receiving element comprises a strut receiving socket and is positionable along said curved substrate wherein the longitudinal axis of struts attached therewith intersect the axis orthogonal to the said common axis of the said hub.

17. A connector element for a space structure of the type utilizing a plurality of struts, said connector element comprising a first subpart, said first subpart comprising at least one strut receiving element having a strut receiving socket and a pintle and a second subpart comprising at least one strut receiving element having at least one hinge knuckle sized and arranged for capturing said pintle to enable said first and second subparts to rotate with respect to one another about an axis established by said pintle.

18. A hub for creating a space structure of the type utilizing a plurality of struts, said hub comprising a first connector element and a second connector element, each of said first and second connector elements comprising a first subpart, said first subpart comprising at least one strut receiving element having a strut receiving socket and a pintle and a second subpart comprising at least one strut receiving element and at least one hinge knuckle sized and arranged for capturing said pintle to enable said first and second subparts to rotate with respect to one another about an axis established by said pintle, said first and second connector elements being releasably connected to one another by use of a clip whereby said pintles of said first and second connector elements align along a common axis.

19. The hub of claim 18 where said clip is a split clip comprised of hinge knuckles to releasably secure the pintles of the said connector elements to each other, wherein said connector elements and said connector element subparts all independently rotate relative to each other about their said pintles along a common axis.

20. The hub of claim 19 wherein said split clip further comprises at least one strut receiving element.

21. The hub of claim 18 where said clip is a hinge clip comprised of first and second subparts.

22. The hub of claim 21 where the said first and second subparts of the hinge clip attach to the other via the use of a hinge.

23. The hub of claim 22 where the axis orientation of said hinge of the hinge clip is orthogonal to the said pintles and said common axis of said connector elements to which the said hinge clip is attached allowing said first and second connector elements to rotate about each other along an axis orthogonal to the common axis with which the first and second connector elements' first and second subparts rotate.

24. The hub of claim 18 where at least one of the said subparts of the said hub is in the form of a split slider hub subpart providing a curved substrate in the form of a semi-toroidal contour emanating from said subpart and at least one strut receiving element removably attached to said curved substrate.

25. The hub subpart of claim 24 wherein said removably attached strut receiving element is positionable along said curved substrate about an axis orthogonal to the said common axis of the said hub.

26. In a construction toy of the type comprising a plurality of hub-like connector elements and a plurality of structural elements adapted to be removably engaged with said connector elements to form a composite structure, the improvement comprising a connector element comprising first and second subparts, at least one strut receiving element having a strut receiving socket emanating from each of said subparts, said subparts being rotatable with respect to one another along a common axis.

27. The construction toy of claim 26 wherein a plurality of strut-receiving elements radiate from each of said subparts wherein the longitudinal axis of struts attached therewith intersect a central point of said construction toy.

28. The construction toy of claim 26 wherein said subparts are attached to one another by use of a hinge.

29. The construction toy of claim 28 wherein each of said subparts comprises a pintle, wherein said first subpart rotatably and releasably captures the pintle of said second subpart and second subpart captures the pintle of said first subpart.

30. The construction toy of claim 29 wherein the pintle of said first subpart and the pintle of said second subpart align with one another along a common axis wherein said subparts are attached to one another.

31. The construction toy of claim 29 wherein at least one hinge knuckle is provided in said first subpart for capturing the pintle of said second subpart and at least one hinge knuckle is provided in said second subpart for capturing the pintle of said first subpart.

32. The construction toy of claim 31 wherein said subparts are beveled from said hinge knuckles as said subparts extend therefrom.

33. The construction toy of claim 26 wherein said first and second subparts are identical to one another.

34. The construction toy of claim 28 further comprising at least one strut receiving element releasably attachable to said construction toy.

35. The construction toy of claim 34 wherein said at least one strut receiving element is releasably attachable to said pintle and rotatable about said pintle independently of said first and second subparts.

36. The construction toy of claim 26 where said receiving socket comprise outwardly extending gripping arms parallel to longitudinal axis of said attached strut adapted to releasably receive said strut therewith.

37. The construction toy of claim 36 wherein said gripping arms provide for lateral insertion of the said strut therewith, and include concave recesses extending in a direction parallel to the axis of said gripping arms and said struts to confine said strut from lateral movement relative to said gripping arms.

38. The construction toy of claim 36 wherein said gripping arms comprise at least one locking projection to mate to a corresponding annular groove configured within the said strut coaxial to the strut's longitudinal axis to restrain its axial release.

39. The construction toy of claim 26 further comprising at least one slider hub subpart providing a curved substrate emanating from said slider hub subpart and at least one strut receiving element removably attached to said curved substrate.

40. The construction toy of claim 39 wherein said curved substrate is in the form of a semi-toroidal contour wherein the axis of which is orthogonal to said common axis about which said subparts are rotatable with respect to one another.

41. The construction toy of claim 39 wherein said strut receiving element comprises a strut receiving socket and is positionable along said curved substrate wherein the longitudinal axis of struts attached therewith intersect the axis orthogonal to the said common axis of the said hub.

42. In a construction toy comprising a plurality of hub-like connector elements and a plurality of structural elements adapted to be removably engaged with connector elements to form a composite structure, the improvement comprising a connector element having a first subpart, said first subpart comprising at least one strut receiving element having a strut receiving socket and a pintle and a second subpart comprising at least one strut receiving element having at least one hinge knuckle sized and arranged for capturing said pintle to enable said first and second subparts to rotate with respect to one another about an axis established by said pintle.

43. In a construction toy comprising a plurality of hub-like connector elements and a plurality of structural elements adapted to be removably engaged with connector elements to form a composite structure, the improvement comprising a hub having a first connector element and a second connector element, each of said first and second connector elements comprising a first subpart, said first subpart comprising at least one strut receiving element having a strut receiving socket and a pintle and a second subpart comprising at least one strut receiving element and at least one hinge knuckle sized and arranged for capturing said pintle to enable said first and second subparts to rotate with respect to one another by use of a clip whereby said pintles of said first and second connector elements align along a common axis.

44. The construction toy of claim 43 where said clip is a split clip comprised of hinge knuckles to releasably secure the pintles of the said connector elements to each other, wherein said connector elements and said connector element subparts all independently rotate relative to each other about their said pintles along a common axis.

45. The construction toy of claim 44 wherein said split clip further comprises at least one strut receiving element.

46. The construction toy of claim 43 where said clip is a hinge clip comprised of first and second subparts.

47. The construction toy of claim 46 where the said first and second subparts of the hinge clip attach to the other via the use of a hinge.

48. The construction toy of claim 47 where the axis orientation of said hinge of the hinge clip is orthogonal to the said pintles and said common axis of said connector elements to which the said hinge clip is attached allowing said first and second connector elements to rotate about each other along an axis orthogonal to the common axis with which the first and second connector elements' first and second subparts rotate.

49. The construction toy of claim 43 where at least one of the said subparts of the said hub is in the form of a split slider hub subpart providing a curved substrate in the form of a semi-toroidal contour emanating from said subpart and at least one strut receiving element removably attached to said curved substrate.

50. The construction toy of claim 49 wherein said removably attached strut receiving element is positionable along said curved substrate about an axis orthogonal to the said common axis of the said hub.
